(19) United States
(12) Patent Application Publication
(10) Pub. No.: US 2009/0152871 A1
(43) Pub. Date: Jun. 18, 2009

(54) Multiple energy inputs hydropower system

(76) Inventor: Jose Ong Ching, Manila (PH)

Correspondence Address: THE NATH LAW GROUP, 112 South West Street, Alexandria, VA, 22314, US

(21) Appl. No.: 12/081,528

(22) Filed: Apr. 17, 2008

(30) Foreign Application Priority Data
Dec. 14, 2007 (CN) 200710195991.3

(51) Int. Cl. F03B 13/00; F03B 17/04

(52) U.S. Cl. 290/54; 415/916

(57) ABSTRACT

The present invention has incorporated a re-boosting pump to re-boost and to supply additional pressure energy input to a system periodically. The re-boosting pump gets its energy from a starting/re-boosting generator. This works to keep the level of the energy output sustainable.

Another feature of the present invention is that it has incorporated a convergence recoil nozzle that utilizes a recoil force of the water jet. This recoil force which is equal in magnitude and opposite in direction, will push a piston that is inside a pressure chamber. This force is capable of doing different kinds of works, such as a pressurized liquid to add energy input to the system through a pressure pipe into the main penstock or it can be used as a pressure energy for the desalination of saline water.

### FIELD OF THE INVENTION

The present invention relates in general to power generation system. More specifically, it relates to a multiple energy inputs hydropower system which synergistically harnesses the elevation head; the velocity head and the elastic potential energy of water to generate electric power.

### BACKGROUND OF THE INVENTION

Force is defined as vector quantity that pushes or pulls a body or mass. It can be nature induced or machine induced. The unit of measure is in Newton (n). A force that produced displacement (m) constitute work (n×m). The applied force is proportional to the displacement produced. The bigger the force applied on a particular mass, the bigger would be the displacement.

Mechanical energy is defined as a capacity to do work. It produces work which involves a quantity of force. Energy is expressed in terms of work; because work is also the measured amount of energy that is transferred. Both are measure in terms of joules or Newton-meter (n×m).

There is latent quantity of force existing in the mechanical energy. Mechanical energy can produce force as in the force applied on a compression spring is proportional to the displacement or its change in length Δm. The word done on the spring is equal to the elastic potential energy (n×m) and it is stored in the spring. Upon release of the compressive force, this elastic potential energy will perform an amount of work, producing a quantity of force (n) that could elongates the spring a length Δm. Although the two quantities—force (n) and energy (n×m) are not equal nor even similar, they however are intrinsically intertwined.

According to the law on conservation of energy, energy cannot be created nor destroyed; but it can be transformed, transferred, accumulated, stored and either be harnessed for constructive use producing usable energy or be converted into various dissipated forms.

At present, the prominent hydroelectric power plants are sited on great natural waterways, e.g. the Hoover Dam on Colorado River. The building of dam and elevating the height of the water surface to provide the stored volume and increase the elevation head of the waterways constitute the main features of our present day hydropower system. The single energy input is the natural gravitational force induced elevation head which is transformed either into velocity head to run an impulse turbine or into pressure head to run a reaction turbine. The single output is converted into electrical energy. This conventional hydropower has no input in the form of electrical energy.

Hydropower is considered as one of the best, if not the best form of energy. It is clean, relatively economical as it is being recycled by Mother Nature through the water cycle. No fossil fuel is used. Thus, no harmful gases are emitted to the atmosphere.

Hydro-electric power plant however, has its limitations and shortcomings.

First, it is available only to sites or areas where there are big natural waterways. These sites are usually found in far flung areas where the power transmission lines to the cities are not only expensive, but also cause power losses.

Second, its operation is entirely dependent on the seasonal precipitations, such that its average annual output is only about 50% of the installed capacity.

Third, building dams could inundate farmlands and it could carry heavy social costs.

Fourth, the construction time of a dam is very long.

Fifth, the required civil works are expensive.

Sixth, the continuous removing of the upstream debris is tedious maintenance work, and the sedimentation problem is always present.

And lastly, there is always the danger of dam failure that could result to catastrophic consequences to lives and properties.

Many patents have been issued attempting to overcome the limitations and drawbacks of the conventional hydroelectric power plant.

In U.S. Pat. No. 6,420,794 issued to Cao there is disclosed a hydropower conversion system for circulation of water between a delivering reservoir and a receiving reservoir through hydro-turbines and back-up reservoir. Water in the delivering reservoir is maintained at a constant functioning level by adjusting valve (AV) linked with valve control mechanism (VCM) to adjust the opening and closing of passages conducting water flowing from the back-up reservoir into the delivering reservoir. Outlets allow excess water to flow out of the back-up reservoir back down to the receiving reservoir. The hydro-turbines are connected to power machinery. The pumps are driven by a natural energy source. In one embodiment, the receiving and delivering reservoirs are structurally connected; in another embodiment, the two reservoirs are separate reservoirs.

Though this prior art has various input energy derived from erratic natural sources, such as winds, sunlight, waves, tidal changes, etc. and would therefore solves the low water level problem of the dam, the other inherent problems linked to the conventional hydro electric plant like the dependence to the annual precipitation and requirement of vast area, were not overcome.

On the other hand, U.S. Pat. No. 6,388,342 issued to Vetterick, Sr. et al. on May 14, 2002, disclosed a hydroelectric plant which includes an apparatus and method for converting renewable wave action energy to electrical energy that harnesses fluid wave power by employing a plurality of low-mass buoys floating on a fluid surface connected to low-volume pumps. The pumps transfer fluid from a source to an elevated storage tank. There, the water can be held in the tank as a reserve, when not being immediately used to generate electrical power. When there is a demand for electrical power, the reserve is released from the storage tank and flows, by gravity, through a hydro-electric generator creating an electrical current.

Though the above prior art harnesses the renewable wave energy into useable electrical power to meet peak load periods, still it does not address the other inherent problems associated to the conventional hydroelectric power plant.

In another patent, U.S. Pat. No. 4,965,998 issued on Oct. 30, 1990 to Estigoy et. al, the problem of dependence on water precipitation of the hydro-electric plant was partly addressed by providing a pump, driven by the turbine itself, which recycles the water discharged from the said turbine. Specifically, the turbine has a first driving means to drive the electric generator and a second driving means to drive the pump which recycles the discharge water back to the reservoir. This patent, however, is intended to work only as a mini hydroelectric power plant.

Another prior art was the one published under WO2006/05782 entitled “Recirculating Water in a Closed Loop Hydropower System”, in the name of the herein inventor-applicant, which prior art is expressly incorporated by reference herein in its entirety. This hydropower system is subjected to the dissipated frictional force and the constant gravitational force which wanes the energy output and eventually exhaust the energy content of the system.

### SUMMARY OF THE INVENTION

The aim of the present invention is to overcome the shortcomings of the aforementioned prior arts. The present invention has added new equipments and features to achieve this purpose.

Primarily, the present invention has incorporated a re-boosting pump (27) to re-boost and to supply additional pressure energy input to the system periodically. The re-boosting pump gets its energy from the starting/re-boosting generator (3). This works to keep the level of the energy output sustainable.

Another feature of the present invention is that it has incorporated a convergence recoil nozzle (29) that utilizes the recoil force of the water jet. This recoil force which is equal in magnitude and opposite in direction, will push a piston (31) that is inside a pressure chamber (30). This force is capable of doing different kinds of works, such as a pressurized liquid to add energy input to the system through the pressure pipe (34) into the main penstock (9), or it can be used as a pressure energy for the desalination of saline water.

The present invention is an improved and a much enlarged hydropower system. It is powered by eight forms of forces which are mostly naturally occurring. A big portion of the whole range of energy inputs are converted into electric energy; with only one kind of input that consumes electric energy—that being the motor pumps. This fractional input of electric based energy is smaller than the single SINGLE CONSOLIDATED OUTPUT of electric power generated by the whole conversion system. This system is in a closed loop with a controlled volume of water re-circulating continually within. Periodically, it is re-boosted by a re-boosting pump outside of the energy loop as energy output wanes.

Initially, water from a ground level reservoir is given a boost in pressure head by a motor pump to push forward in a 1200 meter long main penstock; passing by pressure relief valve; surge tanks; vacuum suction pipes; auxiliary pipes; periodic re-boosting pipe and ends with a uni-direction spherical valve high up inside the powerhouse.

The continuously rotating spherical valve stops the fast water column in a “rapid closure” mode, transforming the combined pressure, kinetic and elastic energies accumulated in the entire water column into a water hammer of immense pressure energy. As the spherical valve re-opens, pressurized water is re-transformed into a high kinetic energy jet that shoots out of the main penstock to impinge on the Pelton turbine generator to produce electric energy.

The spent water is received by the tail reservoir. It is then drained by gravitational force through the outflow pipe back to the original main reservoir completing the loop.

This system has a complementary sub-loop of re-circulating water path. When the spherical valve is opened rapidly, huge volume of high compressed water jets out of the main penstock, forming a low pressure vacuum upstream. The accompanied suction force would pull in water from the reservoir directly inot the main penstock through the vacuum suction pipes, bypassing the main pump. This operates as the high pressure energy is transformed into a low pressured vacuum condition forming suction force. This mechanisms of water transferring functions like an electric pump but without consuming any electric power. This works to stabilize the pressure and to increase significantly the volume of water in the main penstock. An auxiliary pump (24) sustains the pressure and the volume of water needed. The water jet impinges on the Pelton turbine generator to produce electric energy.

Simultaneously as jet is being forced out of the re-coil nozzle (29), an equal and opposite in direction force is exerted on the recoil nozzle which can do different kinds of work. One embodiment is to move the piston inside a pressure chamber (30) to push liquid in the pressure pipeline (34) to add pressure to the system.

The spent water is received by the tail reservoir. It is drained by gravitational force back to the originating main reservoir (1) completing the complementary sub-loop.

These water flow loops are congruent with the energy flow loops.

The recoil force can also be used to do other methods of work: (A) its reciprocating action can drive a linear to continuous rotary motion assembly where the rotating element is coupled to the rotor of a generator to produce electricity; (B) another method is to utilize the pressure force to run a desalination tank where salts and dilutes are removed by membrane thru reverse osmosis or other process.

As with all moving energy system subjected to dissipative friction and gravity, it will eventually wane its power output; therefore an out of the energy loop re-boosting pump is used periodically to sustain the intended power output.

The present invention is a system that has several advantages over the traditional or conventional systems.

First, is uses controlled volume of water to generate power in a recycling mode, thus its utilization rate is much higher.

Second, site selection is very wide. It can be built adjacent to big load centers without long transmission line. The site can be any flat plain or a mountain plateau with slope and plain. It should be near a natural source of water either above ground or sub-terrain, fresh or saline.

Third, the construction time is much shorter.

Fourth, it is less expensive.

### BRIEF DESCRIPTION OF THE DRAWINGS

FIG. 1 shows the upstream of the system with the main pump (6); gate valve (8); pressure valve (12); two surge tanks (13) and the main penstock (9);

FIG. 2 shows the Pelton turbine generator (14 and 15) receiving water jet from main penstock A (9-A) which is completely opened while the opposite main penstock B (9-B) is completely closed. (recoil nozzle is omitted for clarity).

FIG. 3 shows the main uni-direction spherical valve (5) in a rotating sequence, forming water hammer pressure in the main penstock. Then releasing its power as transformed kinetic energy water jet.

FIG. 4 shows the frontal view of the uni-direction valve;

FIG. 5 shows the projected graph of the discharge from the main penstock.

FIG. 6 shows the projected graph of two discharges from the two main penstock overlapping as a function of time.

FIG. 7 shows the auxiliary pump (24) and the auxiliary uni-direction spherical valve (26) that draws water from the main reservoir.

FIG. 8 shows the recoil nozzle (29) with a pressure chamber (30) attached to the end of the spherical valve (5). The nozzle has an air chamber (29-a); an exhaust orifice (29-b); mechanical spring (29-e); support columns (29-c) and guide rail (29-d). Inside the pressure chamber is the piston (31) that will force the liquid out of the chamber into the pressure pipe (34) to add pressure force to the main penstock (9) and that will draw in liquid through the suction pipe (32) as the piston moves back expanding the space of the chamber.

FIG. 9 is the plain view of FIG. 8 showing the compression phase of the recoil nozzle with the pressure chamber (30).

FIG. 10 shows the relative positions of the main spherical valve (5) and the auxiliary spherical valve (26) as a function of time.

FIG. 11 is the plane view of the present invention of power conversion system together with the out of the loop re-boosting pump (27).

FIG. 12 is the diagram of the present invention of power conversions system energy flow paths showing the closed energy loops plus the out of the loop re-boosting energy input.

FIG. 13 shows the replenishment pipe (21) drawing water from nearby natural source of water into the reservoir of the system; and

FIG. 14 shows the second embodiment of the present invention—elevation head in an upper reservoir (22) substituting the main pump (6) pressure head as an energy input.

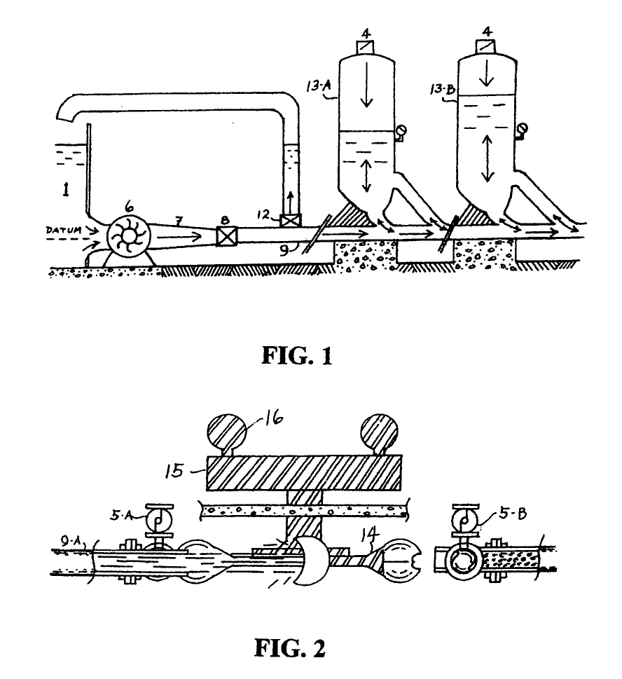

### DETAILED DESCRIPTION OF THE INVENTION

Water hammer is defined as the excess pressure (above the normal hydraulic gradient line pressure)—brought about by the sudden change of water flow velocity in a closed pipeline. The highest water hammer pressure is formed when the valve is in a “Rapid Closure” i.e., the valve closing time <2 L/Wp, where L is the length of the pipeline and Wp is the celerity or pressure wave of water which is about 1,476 m/s at 20° C. The celerity is a function of its modulus of elasticity Eᵥ. The modulus of elasticity of water is 2.18×10⁹ n/m². The formula for celerity is Wp=(Eᵥ/Dₘ)^{1/2}; where Dm is the density of the liquid. Then Wp=[(2.18×10⁹ n/m²)/1000 kg/m³)]^{1/2}≈1476 m/s

The total pressure at the penstock would be equal to the water hammer pressure plus the original steady state flow pressure head.

The present invention uses water; air and electro-magnet as mediums for energy conversions. Various forms of natural forces are collected and transformed into a distinctive power conversion system. Permanent forces such as gravitational force, atmospheric air pressure and other dynamic forces, i.e. water hammered jet force; vacuum suction force; jet recoil force; compressed air pressure and inertia can be harnessed to form substantial inputs of a power conversions system to generate electrical energy by means of a Pelton turbine-generator.

The illustrations and calculations of the system are presented on the following specifics:

(A) Fresh water is used as the medium. At sea level, fresh water has a density of 1,000 kg/m³ and sp. wt. of 9.81 kn/m³. On a broader scope, other liquid can be used. If sea water is used, then the figure is about 3% higher. The density is then 1030 kg/m³.

(B) The inner diameter of the main penstock is one meter. On a broader scope, it can range from 30 cm. up to one meter.

(C ) The head of the pump is 260 meters. On a broader scope, it can range from 130 meters to 400 meters and up.

The formula for calculating the water hammer pressure is:

Pₕ=DₘV Wp

Where Dₘ is the mass density of liquid. For fresh water, it is 1,000 kg/m³
V is the velocity of the flowing water inside the penstock in a steady state, term is in m/s.
Wp is the pressure wave velocity inside the penstock, unit is in m/s. At 20° C., it is about 1478 m/s. It is an inherent property of water.

After about one minute of the pump start-flow, a steady flow of water with velocity of 12.66 m/s is achieved, it is then rapidly closed by a valve. Assuming the Wp is 1,428 m/s, then the water hammer pressure in the pipe with length of about 1200 meters is calculated as:

$$\begin{matrix}{P}_{h} = {D}_{m} VWp \\ = 1 , 000 kg \text{/} {m}^{3} ( 12.66 m \text{/} s ) ( 1 , 428 m \text{/} s ) \\ = 18 , 078 , 480 ( kg \cdot m \text{/} {s}^{2} ) ( 1 \text{/} {m}^{2} ) \\ = 18 , 078 , 480 n \text{/} {m}^{2} \\ = 18 , 078 kpa\end{matrix}$$

in term of energy head, the formula is: P/Wsp,

where P is the pressure force, unit is in n/m²
Wsp is the specific weight of water which is about 9810 n/m³.
   Therefore: the energy head=18,078,480 pa/9810 n/m³=1,842 meters.

This 1,842 meters of water hammer pressure head is much higher than the velocity head possessed by the liquid in the original steady state of flow.

We solve for the velocity head Hv of the original steady state flow of 12.66 m/s

$$\begin{matrix}Hv = \frac{{Vel}^{2}}{2 g} \\ = \frac{{12.66}^{2}}{19.62} \\ = 8.17 meters\end{matrix}$$

The big disparity in the energy head, from the original head of 8.17 meters to the induced and accumulated high pressure head of 1850 m. (1842+8.17) is one of the basic features of the present invention. This will turn the destructive force of water hammer pressure into a constructive force and transform it into usable electrical energy.

It is an accepted scientific fact that there exists a latent pool of kinetic energy in the inter-molecular spaces of liquid, even it is at rest. This is the result of the constant movements and collisions of the molecules. This is known as the Brownian motion. This activity is also characterized as a motive force or as a form of inter-molecular interactions of liquid.

These interactions act like “miniscule springs” in between the molecules. As the atmospheric liquid undergoes high compression, the volume is diminished; squeezing the inter-molecular spaces. This compressive force will convert the latent kinetic energy into an added potential elastic energy. This is on top of the supplied pressure energy from the main pump (6).

This phenomenon intensifies the water hammer into a pressure of immense proportion.

In our example case, it's volume is compressed short by 0.83%, or about 10 meters of water column. This volume will be released as a high kinetic energy jet instantaneously as de-compression to the atmosphere occurs.

### Structures & Equipments of the System

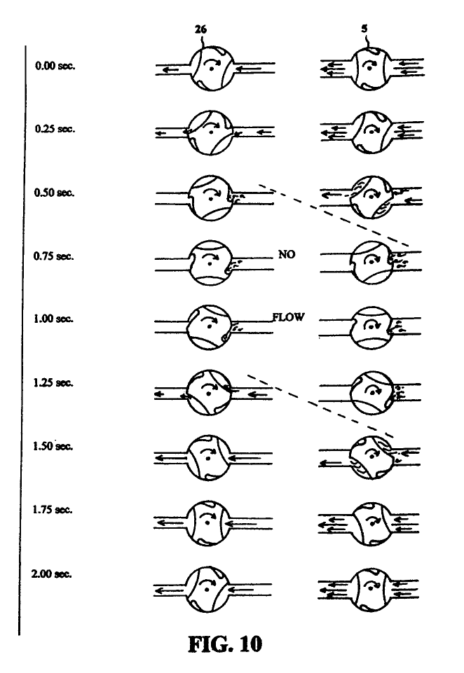

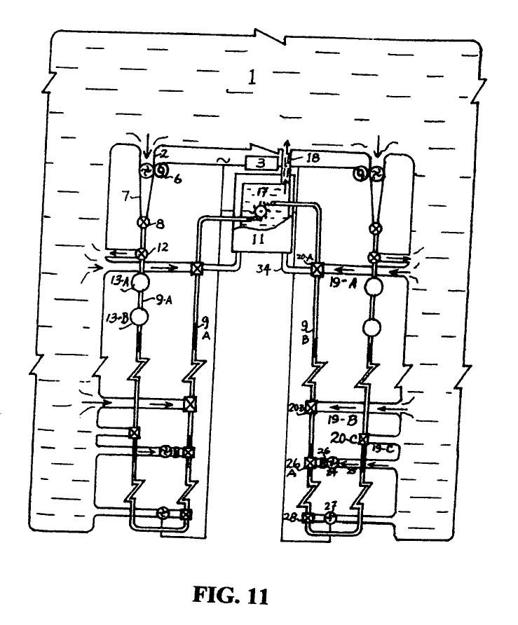

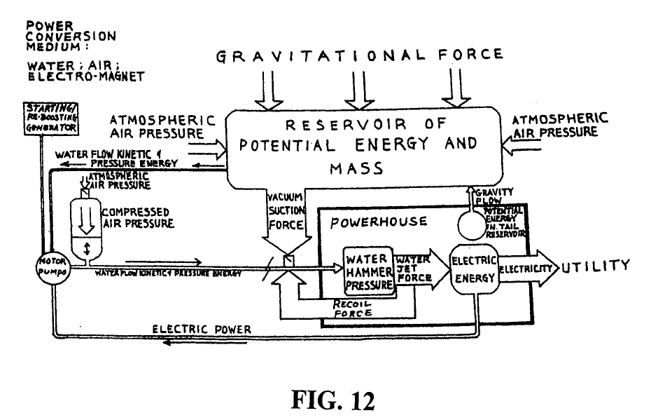

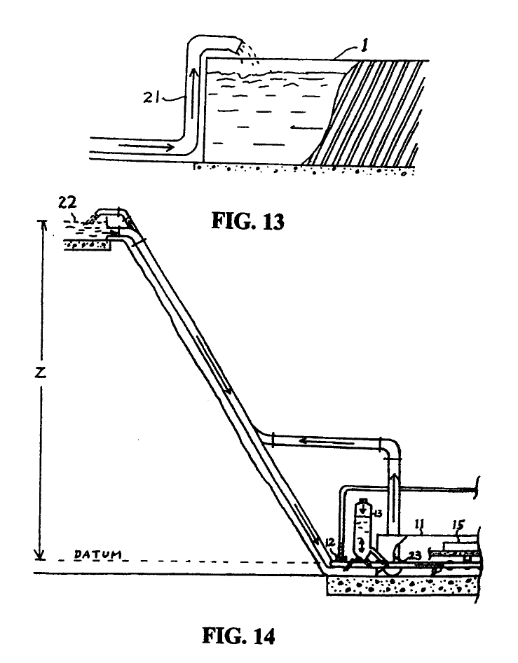

On FIG. 11 is a diagram of the plane view of the present system. It has the following structures and equipments:
A. A main reservoir (1). A man made or natural body of water which surface area is wide enough to also serve as a cooling reservoir; it must have at least three meters of elevation head from the datum line;
B. Rounded entrance conduit (2);
C. Starting/re-boosting generator (3), it supplies the initial power to the pump (6) and the spherical valves (5), it also re-boost the energy level of the system as the energy output wanes over time;
D. Main pump (6) provides the pressure head to the main penstock;
E. Convergence pipe (7);
F. Gate valves (8), these valves control the water volume flowing into the main penstocks (9);
G. Two main penstocks (9-A & 9-B), each with about 1200 m. with one m. inside diameter that end about 10 m. high inside the powerhouse (11);
H. Pressure relief valves (12) set on a water release pressure of about 10 meters above the pump energy head in order to protect the pump. Water hammer pressure surge that reaches this point collides with the pump pressure flow. That resultant upsurge in pressure would push open the pressure relief valve allowing the excess pressurized water to flow out of the main penstock and into the main reservoir (1);
I. Air cushioned surge tanks (13-A & 13-B) absorb surge water from the main penstock during the high pressured compression and release water back to the main penstock during the low pressured expansion. On their tops are equipped with vacuum relief valves (4) that are naturally closed to prevent the escape of air while allowing air to flow into the surge chambers during the low pressure expansion;
J. Main uni-direction spherical valves (5) connected to the end of the main penstock (9);
K. A Pelton turbine (14) shown in FIG. 2 with a shaft that is coupled to the main generator (15) which has inertia flywheels (16) to store and to release back energy to the rotor to sustain the optimum speed;
L. A recoil nozzle (29) with a pressure chamber (30) attached to the spherical valve (5) as shown in FIGS. 8 and 9. The nozzle has an air chamber (29-a); an exhaust orifice (29-b); mechanical spring (29-e); support columns (29-c); and guide rail (29-d);
M. The pressure chamber (30) has a piston (31) that moves back and forth in synchrony with the released jet force; liquid is forced out into the pressure pipe (34) through a one way valve (35) during compression phase and liquid from tail reservoir is pulled in during vacuum decompression phase through the suction pipe (32), flow is controlled by a check valve (33); the chamber can be converted into a desalination tank where the salts and other solutes are removed by the reverse osmosis process by using semi-permeable membrane;
N. A tail reservoir (17) inside the powerhouse; it receives spent water and drains it to the main reservoir (1) via the drain pipe (18) by gravitational flow;
O. Water vacuum suction pipes (19-A; 19-B & 19-C) to provide immediate water needed to stabilize the pressure in the main penstock. Water is sourced directly from the main reservoir (1). All have check valves (20-A; 20-B and 20-C) set below the main penstock (9) to prevent backflow. The drawn in volume from the suction pipes into the main penstock is based on the magnitude of the suction force. It is in accordance with the Principle of Conservation of Energy. That's when high pressure energy is transformed into a low pressured kinetic energy, vacuum is formed;
P. Auxiliary pump (24) powered by an electric motor that will draw water from the main reservoir into the main penstock to provide the water volume needed for next water hammer;
Q. Auxiliary pump line (25) connects the auxiliary pump to the main penstock; its inside diameter is one half that of the main penstock;
R. Auxiliary spherical valve (26) controls the flow of water into the main penstock, its dimensions and rotating speed are similar to the main spherical valve (5), as shown in FIG. 10, both the auxiliary spherical valve (26) and the main spherical valve (5) are rotating in a relative positions in relation to time; it incorporates a check valve (26-A) immediately downstream to prevent the water hammer pressure from dissipation;
S. Re-boosting pump (27) re-energizes the system by adding power input periodically as the power output is waning, power source is the starting/re-boosting generator (3) which is outside of the closed energy loop;
T. Check valve (28) on the entrance of re-boosting pipe to main penstock;
U. A replenishment pipe (21) draws water from the nearby natural water source into the main reservoir to replace the evaporated water (FIG. 13);
V. An upper reservoir (22) shown in FIG. 14 of the second embodiment of the present invention where the elevation head substitutes the pump pressure head of the first embodiment;
W. Motor pump (23) for the delivery of water up to the upper reservoir (22) of the second embodiment in FIG. 14.

### The Flow Path of the Re-Circulating Water in the System

FIG. 11 shows water initially flows out from the main reservoir (1) into the entrance pipe (2). It gets a high pressure head from the main pump (6). Then it flows into the convergence pipe (7), passes by the gate valves (8) and into the main penstocks (9). The main penstock has a length of about 1200 meters. The water would flow by the pressure relief valve (12) and the two air surge chambers (13-A & 13-B). These surge chambers provide spaces to absorb surge water during compression phase in the main penstock and release water back to it during the expansion phase. Water then flow forward on the long main penstock, passing by check valves (20-A; 20-B & 20-C) that control the entrance of water from the vacuum suction pipes (19-A; 19-B & 19-C). As the water flows to the end of the main penstock, it will meet the uni-direction spherical valves (5-A & 5-B) in operation inside the powerhouse (11). These motorized spherical valves induce the water hammer pressures in the main penstocks and then releases the high kinetic energy jet through the recoil nozzle into the Pelton turbine-generator to generate electricity. The spent water now falls down into the tail reservoir (17) of the powerhouse (11). Water is now drained by gravitational force through the drain pipe (18) into the main reservoir (1), thereby COMPLETING THE WATER CIRCULATION LOOP.

The water vacuum suction pipes are connected to the main penstock. As the downstream water in the main penstock is jetted out in huge volume creating a low pressured vacuum which suction force will pull in water directly from the main reservoir (1) into the main penstock. Together with the water pumped in by the auxiliary pump (24) and the recoil forced pressure pipe (34) COMPLETES THE CIRCULATION OF WATER IN A COMPLEMENTARY SUB-LOOP—from the main reservoir through the vacuum suction pipes and the auxiliary pipe to the main penstock—turbine—tail water reservoir and back to the main reservoir (1) bypassing the main pump (6) and the upstream section of the main penstock.

### Operations of the Motorized Uni-Direction Spherical Valve

In FIG. 2 is shown the two spherical valves (5-A and 5-B) that rotate in a uni-direction mode (the recoil nozzles are omitted for clarity). It shows the horizontal Pelton turbine (14) with a vertical shaft coupled to the rotor of the main generator (15).

Valve 5-A is in a fully opened position while the valve 5-B is in the fully closed position. Both valves have the same dimensions and are operated by motors that rotate continually.

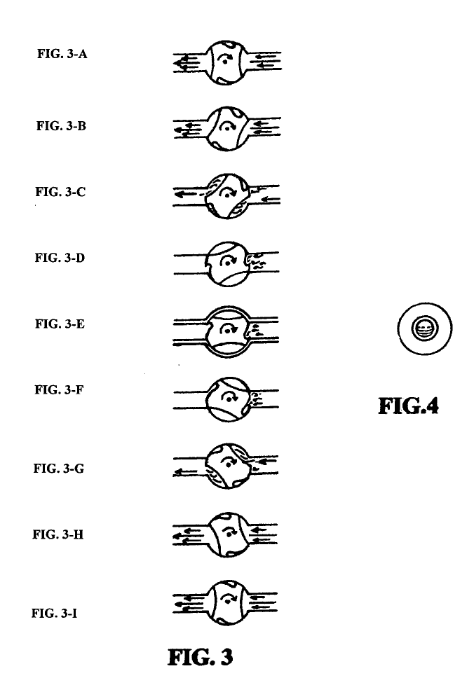

From FIG. 3-A to FIG. 3-I are shown the valve inner sphere having outlet or orifice that occupies one fourth of its circumference, as does the inlet orifice. In such a manner, it is at any time divided into four equal sections; two parts that would open up and two parts that would close the spherical valve down. The main penstock inside diameter is about one half the orifice diameter of the sphere.

The valves are opened in one half second time interval (FIG. 3-F to FIG. 3-H) and stays open for the following one half second time interval (FIG. 3-H to FIG. 3-I and FIG. 3-A to FIG. 3-B). It closes in the next one half second time interval (FIG. 3-B to FIG. 3-D) and stays closed for the following one half second time interval (FIG. 3-D to FIG. 3-F). The two valve spheres have a frequency of one revolution per four seconds that make them 15 RPM valves. Their respective positions, i.e., opening and closing are timed to be one second apart as shown in FIG. 6 and FIG. 10. In FIG. 2, it shows that when valve 5-A is fully opened, valve 5-B is fully closed and vice-versa.

FIGS. 3-A to 3-I show the sequence of the spherical valve in its movements. At both sides of the sphere are two “toy top” concaves. The concaves increase the surface area and torque of that section exposed to the increasing water hammer pressure as the valve closes and opens.

The formula relating force to pressure and area is:

F=P×A

Force=Pressure×Area; n=n/m²×m²

As the formula indicates, area is directly proportional to the force. The bigger the exposed area, the greater force it could receive. This condition would create an unbalanced force on the sphere. That is, a greater force would exert on the portion with the concave depression than on the part without the depression. And this unbalanced force helps to increase the overall rotating torque of the spherical valve. Thus a calculated lesser capacity motor may be used.

FIG. 4 is the frontal view of the spherical valve showing the “toy top” depression on the sphere.

The valve should be made of very strong steel material that would withstand the constant adverse dynamic forces of the water hammers.

The rotor in the main generator (15) should possess enough mass that its moment of inertia (M·R²) is sufficiently increased to compensate for the pulsating jet energy mode. Therefore it needs to install flywheels. (16)

### Volume of the Compressed Water Column

The formula for calculating the rate of compression R_{c} of water under high pressure is: R_{c}=−P/Eᵥ

where P is the applied pressure, unit is in kpa.
Eᵥ is the modulus elasticity of water. At 20° C., its 2.18×10⁶ kpa.

In our specific penstock of 1200 meters in length and one meter in inside diameter. At 20° C., it is subjected to a pressure head of 1,850 meters or pressure units of 1,850×9.81 kn/m²=18,148 kpa. The rate of compression of water is:

$$\begin{matrix}{R}_{c} = - P / {E}_{v} \\ = - 18 , 148 kpa / ( 2.18 \times {10}^{6} ) kpa \\ = - 0.0083\end{matrix}$$

The pressure of 18,148 kpa will compress the water by 0.83%. To arrive at the compressed volume, we multiply the original volume by 0.83% which is 1200 meters×0.785×0.83%=7.82 m³. The length of the water column is shrunk by 7.82 m³/0.785 m²=9.96 METERS. The more compressed the water column, the shorter is its length and the higher is its stored ELASTIC POTENTIAL ENERGY. This elastic potential energy is converted from the latent kinetic energy in the inter-molecular spaces.

### Modified Pressure Wave Velocity

AT 20° C., the speed of the pressure wave in water is 1,478 m/s. However, in an elastic pipe, it is modified by the stretching of the pipe walls. In general, the thicker the steel, the higher is the celerity. In this illustration, it is modified by steel material and its thickness of 15 cm. Using the modified pressure wave MWp formula:

MWp=Wp{1/[1+(Ev/E)(D/t)]}^{1/2}

where Wp is the water pressure wave velocity at 20° C.
Ev is the modulus of elasticity of water which is 2.18×10⁶ kn·m⁻²
E is the bulk modulus of the pipe material. For steel, it is about 207×10⁶ kn·m⁻².
D is the inside diameter of the pipe which in this case is one meter.
t is the thickness of the pipe which in this case is 0.15 meter.

Then:

$$\begin{matrix}MWp = Wp {\{ 1 / 1 + [ ( 2.18 \times {10}^{6} ) / ( 207 \times {10}^{6} ) ] \times [ 1 / 0.15 ] \}}^{1 / 2} \\ = 1478 {\{ 1 / ( 1 + 0.07 ) \}}^{1 / 2} \\ = 1428.8 m \text{/} s\end{matrix}$$

The pressure wave in this specific pipe with water temperature at 20° C. is 1428.8 m/s.

### Calculated Performance of the System (Without the Recoil Force Input)

By using a 260 meter head pump, the energy equation of the flow inside the one meter (inside diameter) main penstock that ends in a 10 meter high orifice is:

260=v²/2 g+H_{TL}+10

the head lost is about 30.8 times the velocity head, thus:

260=(1+30.8)v²/2 g+10

and v=12.66 m/s

This is the steady state flow rate and the discharge is 9.93 m³/s.

The water hammer pressure when the spherical valve is “rapidly closed” in one half second time interval is:

$$\begin{matrix}{P}_{h} = {D}_{m} {VW}_{p} \\ = ( 1000 ) ( 12.66 ) ( 1428 ) \\ = 18 , 087 kpa\end{matrix}$$

In term of pressure head, it is 18,087/9.81=1,842 meters.

From a steady flow velocity head of 8.17 meters, the rapid closure of the spherical valve rams up the energy head to 1,850 meters (1842 plus 8.17) high of pressure head. In a ½ second time, the spherical valve rotates to a fully opened position. In the next full ½ sec. time, the valve is fully opened releasing a high kinetic energy jet to impinge on the Pelton turbine-generator. Then the sphere rotates to close in the next ½ sec. time interval. This release of water jet is simultaneous with the abrupt decrease of pressure head in the penstock.

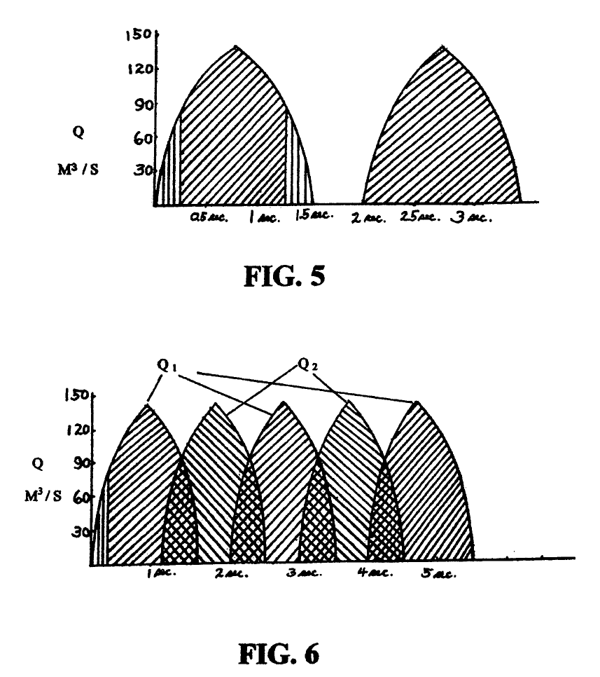

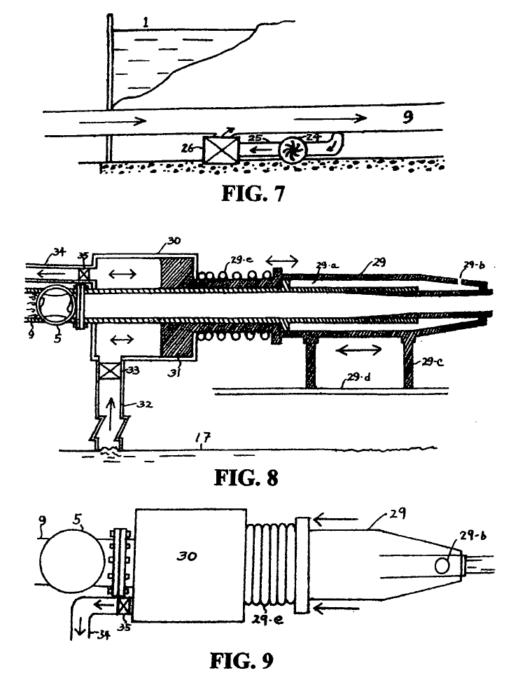

In FIG. 5 shows the projected chart of the water discharge. At T=0 sec., the valve is closed, water is not flowing and the water hammer pressure inside the penstock is 1,850 meters. Then in the next ½ sec., the valve opens fully. At the time interval of T=0 sec. to T=0.75 sec., the pressure head is dropping rapidly. The assumed head would be about 1,600 meters at the instant T=0.75 sec. It should be noted that it is not anymore the pressure head of 1,850 meters.

The velocity head H of water jet has the equation:

H=V²/2 g

Then velocity=[(2 g)H]^{1/2},

Assuming the instantaneous head is 1,600 meters at T=0.75 sec.

then: Vᵢₙₛₜ=[2 g(1600)]^{1/2}=177 m/s.

The equation for instantaneous discharge at T=0.75 sec.:

Qᵢₙₛₜ=A Vᵢₙₛₜ

where A is the area of the pipe opening, unit is in m²
Vᵢₙₛₜ is the instantaneous velocity, unit is in m/s.

For the given area and the instantaneous velocity of 177 m/s, the instantaneous discharge is:

$$\begin{matrix}{Q}_{inst} = {( 1 )}^{2} ( ¶ / 4 ) ( 177 ) \\ = 0.785 ( 177 ) \\ = 139 {m}^{3} \text{/} sec\end{matrix}$$

The projected single water discharge would approximate the curve of the equation: Y=139(2.66X−1.77X²) Given: [0≦X≦1.5]

where Y is the water discharge volume.
X is the time in seconds.

FIG. 5 charts this relationship.

For the second from T=0.25 sec. to T=1.25 sec., the discharge is highest and its power is greatest. By using integration to measure this water discharge Q:

$${\int }_{0.25}^{1.25} 139 ( 2.66 X - 1.77 {X}^{2} ) d X = 139 ( 1.33 {X}^{2} - \frac{1.77 {X}^{3}}{3} ) {[}_{0.25}^{1.25}$$

Q=118.43 m³/sec

From the equation of discharge, we solve for the average velocity:

Vₐᵥₑ=Q/A=118.43/0.785=150.86 m/s

Thus the average velocity head from T=0.25 sec. to T=1.25 sec. is

150.86²/2 g=1,160 meters

To arrive at the approximate hydrodynamic power of the jet from T=0.25sec to T=1.25 sec., we use the formula for power:

Hydrodynamic power=Q WₛₚHₐᵥₑ/1000; unit is in kw.

where Q is the discharge in one second, unit is in m³/s.
Wₛₚ is the specific weight of water, unit is in newtons/m³.
Hₐᵥₑ is the average head of the water jet, unit is in meters.

$$Hence , \\ \begin{matrix}{power}_{t = 0.25 to t = 1.25} = 118.43 ( 9810 ) ( 1160 ) / 1000 \\ = 1 , 347 , 680 kw or 1347.68 MW .\end{matrix}$$

If we calculate the power from the KINETIC ENERGY approach, we would have come up with the following equation:

K. E.=½mv²

where m is the mass of the water jet, unit is in kg. For 118.43 m³, the mass is 118,430 kilograms.
v is the mean velocity of the water jet, In this case, it is 150.86 m/s

Hence: K. E.=½(118,430) (150.86²)=1,347,667 kn·m

This kinetic energy of 1,347,667 kn·m is released in one second time, making the term 1,347,667 kn·m/sec. Since kn·m/sec. is equivalent to the term kw, therefore the power of 1,347 MW is equal to the 1,347 MW we arrived at by using the hydrodynamic power equation.

Assuming an 80% efficiency turbine-generator, then the power generated is 1347.68×80%=1064.8 MW.

As shown in FIG. 6, this discharged power is produced in 1.5 seconds time interval by a single main penstock. Therefore, in theory, the power produced by two main penstocks in one sec. time is (2×1347)/2.5=1077 MW. If only one single main penstock is utilized, then theoretically, the power is about 538 MW.

This generated power is sustained by other natural forces, i.e., vacuum suction force; the jet recoil force; gravitational force; compressed air; inertia; and atmospheric air pressure PLUS the pressures from the auxiliary pump and the periodic re-boosting pump that are channeled into the system.

### Power Needed by the Pumps in the System

The power required by one single pump (6) to give it a 260 meters head in steady state flow is:

Pₚᵤₘₚ=9.93(9810)(260)/1000=25.33 MW

Assuming an efficiency of 80% for the pump, then the power required is 31.66 MW.

Two pumps working simultaneously would require 63.32 MW of power. From the produced power of 1077 MW, we deduct the 63.32 MW for the two pumps and about 20 MW for the auxiliary pump; spherical valves; intermittent re-boosting pump and other equipments in the powerhouse, we would arrive at about 995 MW of transmittable electricity for the utility grid.

### The Jet Recoil Force

The jet recoil force which is EQUAL and OPPOSITE in direction to the force of the released jet can be utilized to do different kinds of works. Primarily: (A) it can be transferred to the main penstock (9) as added pressure power; other methods can be used, such as (B) to drive a reciprocating linear to continuous rotary motion assembly which rotating element is coupled to the rotor of a generator to produce electricity; and (C) to provide pressure force to a desalination tank where salts and solutes are removed by way of filtration membrane.

The force of the jet from T=0.25 sec. to T=1.25 sec. is:

Force=Dm Q V; where Dm is the liquid mass density, unit is in kg/m³.
Q is the discharge, unit is in m³/sec.
V is the velocity of the liquid flow, unit is in m/s.

Then: F=1000(118)(150)=17700 kn. This is the force of the jet, it is also the recoil force on the convergence nozzle.

(A). If a volume of 20 cubic meter of water is designed to be pumped into the main penstock, the discharge calculations are: (neglecting frictional head loss)

Q=Aₚᵢₚₑ×Vₚᵢₚₑ=A_{chamber}×V_{chamber}=20 m³/s

With the pipe having area of 0.785 m² (1 m. inside diameter) and velocity of about 25.4 m/s; while in the chamber the velocity is 2 m/s. Then the area of the cylindrical chamber have to be 10 m² with a diameter of about 3.5 meters.

Q=0.785×25.4=10×2=20 m³/s

The pressure inside the chamber is P=F/A=17700/10=1770 kpa. The pressure head is 1770/9.81≈177 meters.

The velocity head of the pressure pipe (34) is calculated as:

V²ₚᵢₚₑ/2 g=(D_{cham}/Dₚᵢₚₑ)⁴V²_{cham}/2 g=(3.5/1)⁴0.2≈30 meters.

The Bernoulli continuity equation would show the following: (the pipe Hₗₒₛₛ is about 2×v²ₚᵢₚₑ/2 g)

V²_{ch}/2 g+P_{ch}/Wₛₚ+elevation head=V²ₚᵢₚₑ/2 g+Pₚᵢₚₑ/Wₛₚ+hₗₒₛₛ

Then: 0.2 m+177 m+10 m ≈30 m+97.22 m+2(30) m

The power is=QWₛₚH/1000=20 X 9.81×30≈6000 kw

(B). The recoil force is used to generate electricity. It drives a reciprocating linear to continuous rotary assembly where the rotating element is coupled to the rotor of the generator to produce electricity. The net length of the piston is one meter. velocity is one m/s. The recoil force of 17700 kn. can generate about 15000 kn m/s or 15 MW of power. That is after deducting the force needed for the compression of the spring and overcoming the inertia of the nozzle assembly.

(C). The pressure to desalinate seawater is about 8000 kpa. The membraned area for extracting fresh water is: Area=force/pressure=17000/8000=2.2 m². The inside diameter of the desalination tank is=(2.2/0.785)^{1/2}≈1.67 meters.

Another embodiment of the recoil force assembly is to use the unidirectional spherical valve (5) directly as the recoil assembly. Without the convergence nozzle, this assembly has all the above mentioned parts with the same functions, such as the pressure chamber; piston; spring; pressure pipe and its check valve; vacuum suction pipe and its check valve; air chamber; air relief orifice, steel column and guide rail.

### Water Replenishment of the System

As shown in FIG. 13, on a periodic basis, the water replenishment pipe (21) draws in water from the natural source nearby to replenish the loss of water due to evaporation. This is done by flowing water into the main reservoir of the system.

The main reservoir (1) is of sufficient capacity to also serve as a cooling reservoir and is set up outside the powerhouse. It could be a natural body of water. The cooling system serves to cool the heated water that flow through the main penstock (9), the turbine, the transformer and other equipments. This system uses cooler atmospheric moving air as the main cooling agent. The heated water is carried out of the powerhouse together with the spent water in the tail reservoir through the outflow pipe (18) to the main reservoir that is exposed to the atmospheric air for dissipation. The temperature of the cooling reservoir has to be monitored to prevent it from getting too high. In case of high temperature, other cooling methods may be applied.

### Second Embodiment of the Present Invention

The present invention has a second embodiment as shown in FIG. 14 wherein the force of pressure head provided by the main pump (6) in FIG. 11 is being substituted by the force of elevation head from an upper reservoir (22) on top of a mountain plateau as shown in FIG. 14 ; the elevation head Z minus the down flow pipe frictional head loss is equal to the pressure head of the pump; while the other equipments and structures of the second embodiment system are identical in dimensions and functions to the first embodiment system as presented.

This second embodiment system has a motor pump (23) connected to the tail reservoir to deliver water from the lower level up to the upper reservoir (22) for re-circulation. It also has a low level reservoir similar to the main reservoir of the original embodiment outside the powerhouse to dissipate heat and to supply water to the vacuum suction pipes; auxiliary pump pipe line and re-boosting pipe line.

The two embodiments of the present invention would have the same gross power output.

The present hydropower system would have the following chart of Energy/Mass equilibrium wherein the Energy/Mass inputs must be equal to the sum of the Energy Output plus the Energy/Mass losses:

| CONVERTIBLE ENERGY/MASS | | Energy | | Energy/Mass | |
|---|---|---|---|---|---|
| INPUTS = | | OUTPUT + | | LOSSES | |
| A) | Gravitational force induced elevation heads | a. | Generated | a. | Frictional |
| | of the main reservoir and the tail reservoir and | | electrical | | head |
| | specific weight of water at about 9810 n/m³. | | energy of | | loss |
| B) | Velocity head of about 1200 m. jet released | | at least | b. | Energy loss |
| | from converted water hammer pressure that | | 50 MW | | as heat |
| | involves the converted latent kinetic energy | | | c. | Pipe wall |
| | of the atmospheric liquid. | | | | expansion |
| C) | Vacuum suction force formed after sudden | | | | energy loss |
| | huge discharge in the main penstock pulling | | | d. | Machineries |
| | in volume of water directly from the main | | | | efficiency |
| | reservoir, that operates on the Principle of | | | | loss |
| | Conservation of Energy. | | | e. | Evaporation |
| D) | Recoil force of the jet. | | | | of water |
| E) | Compressed air pressure energy inside the | | | | molecules |
| | surge tanks worked by the surging water | | | | |
| | during the compression phase. | | | | |
| F) | Atmospheric air pressure of 10.3 meters of | | | | |
| | water that pushes into the surge tanks during | | | | |
| | the de-compression phase. | | | | |
| G) | Rotation inertial force of the rotor in motion. | | | | |
| H) | Mechanical force of electric motors, used in | | | | |
| | the main pump; the auxiliary pump; the | | | | |
| | periodic re-boosting pump and the | | | | |
| | uni-direction spherical valves. | | | | |
| I) | Mass of water added to the main reservoir | | | | |
| | as needed through the replenishment pipe. | | | | |

The present invention is intended to be used as a base load generator.

Whenever there is a decrease in the load demands, the excess capacity may be diverted to any other purposes within the powerhouse area, or we may opt to lower the rotating speed of the main motor pump (6), so as to decrease the velocity head in the main penstock (9), thus a lower water hammer pressure, producing subsequently a lower level of power.

The present invention can be constructed as an independent power producing unit or it can be built as a sub-generation plant of an existing power plant. Thus the system serves as an energy multiplier.

The above embodiments are given for illustration purposes only. And not by way of limitations and that modifications will become evident to those skilled in the arts which fall within the scope of the claims.

What is claimed is:

1. A hydroelectric system comprising:
a water source to act as the main reservoir (1) on ground level, having at least three meters of elevation head from the datum line
a rounded entrance conduit (2) connected to the water source;
a main pump (6), powered by a variable speed electric motor that pushes the steady state flow of water inside the down-stream main penstock (9);
a convergence pipe (7) connected to the main pump;
a gate valve (8) connected to the convergence pipe to control the flow of water into the main penstock (9);
a thick main penstock (9) of about 1200 m in length that ends high up inside the powerhouse (11) with a steady state discharge of at least 10 m/s or velocity head of five meters, said main penstock (9) having a diameter of at least 30 cm. to 100 cm. with thickness of about 15% of inside diameter, said penstock (9) being made of strong material such as seamless carbon steel with inner surface being coated with a thick layer of smooth and strong material such as brass, which can be re-coated as needed when heavy cavitations or corrosion occurred, whereby its center line serves as the datum line;
a pressure relief valve (12) on top of the main penstock a few meters after the gate valve to protect the pump (6) from residual surge pressure whereby water relieved is flowed out of the main penstock (9) into the main reservoir;
a series of surge tanks (13-A & 13-B) to absorb surge water from the main penstock during high pressured compression and to release water back to the main penstock during low pressured expansion whereby the tanks are fitted with one way pressure relief valves that is normally closed to trap air to form the air compression force during the high pressured compression while allowing atmospheric pressured air to be drawn into the surge tanks during the low pressured expansion;
a uni-direction spherical valve (5), connected to the end of the main penstock which is structured like a ball valve with a through bore that revolves 360° on its axis continuously in a single direction, said valve having a round closure element with matching round seat that permits uniform sealing stress, the through bore on the sphere divides the periphery into four parts, two parts would open up the main penstock and the other two parts would close it down ;on the sphere are two opposite “toy top”shaped concaves on its rotating plane which increase the rotational torque, powered by a motor with a shaft that revolves the closure element continuously whereby its “rapid closure” i.e., time <2L/Cp, converts the combined kinetic pressure, and elastic energy accumulated in the entire water column mostly into a water hammer of at least 1400 meters of pressure energy; whereby at subsequent moment, when the valve re-opens, it re-converts the pressure energy into a high kinetic energy—water jet, said valve having been designed to rotate at about four seconds per revolution; its opening phase is timed to exhaust the water hammer pressure back to the initial lower velocity head; the sphere orifice having diameter 2 times that of the inside diameter of the main penstock where it is strongly anchored with sufficient counter mass, and a convergence recoil nozzle (29) attached to the downstream of the valve (5);
a Pelton turbine-generator (14 and 15) which buckets are impinged by the kinetic energy—jet emanating from the main penstock, said Pelton turbine having a shaft that couples the turbine to the main generator (15) to produce electrical energy, said Pelton turbine being also connected to a flywheel to store and to release mechanical energy to the rotor to sustain an optimum speed with a capacity ranging at least 50 MW and up; whereby a tail reservoir (17) receives the spent water inside the powerhouse (11); a drain pipe (18) drains spent water back to the main reservoir (1) and out of the powerhouse by gravitational force;
a series of vacuum suction pipes (19-A; 19-B and 19-C) connecting the main reservoir (1) to the main penstock (9) and drawing water from the main reservoir (1); each suction pipe has diameter that is about the size of the main penstock; said vacuum suction pipes pull in immediate volume of water needed for the main penstock by the pressure differential as a result of the higher pressure from at least 3 meter of elevation head plus the atmospheric pressure of 10.3 meters of water as against the low pressured partial vacuum created by the sudden expulsion of high pressured water jet; said expulsion converts the hammer pressure head into velocity head with the subsequent precipitous drop of pressure inside the penstock (9) to a low pressured partial vacuum whereby water transfer is controlled by one way valves (20-A; 20-B & 20-C) placed below the penstock (9);
an auxiliary pump (24) that will bring water from the main reservoir (1) into the main penstock (9) to complete enough volume of at least five meters pressure head-water needed for next round of water hammer;
an auxiliary pump line (25) that connects the auxiliary pump (24) to the main penstock, its inside diameter is one half the diameter of the main penstock;
an auxiliary uni-direction spherical valve (26) which has the same dimension and rotation speed as the main spherical valve (5), controls the flow of water into the main penstock, has a check valve (26-A) downstream to prevent water hammer pressure dissipation; both the two spherical valves (5 and 26) have their relative positions as a function of time;
a starting/re-boosting generator (3) to start and to run initially the pumps (6,24,27) and the initial rotation of the spherical valves; said starting/re-boosting generator (3) also function as a re-boost input to be added to the closed energy loop of the system;
a re-boosting pump (27) re-energizing the system periodically by adding input to the closed energy loop to sustain the level of energy needed;
a replenishment pipe (21) bringing in water from nearby natural source to replace the water lost to evaporation as needed to keep the elevation head constant.

2. A hydroelectric system as in claim 1 which features an intentional repetition of induced water hammer pressure mode with the “rapid closure” of the spherical valve (5), combining the kinetic and pressure energy, plus the elastic potential energy which is converted from the pool of latent kinetic energy in the inter-molecular spaces of atmospheric water which are transformed mostly into a high water hammer pressure; wherein the value is the product of its density multiplies by its velocity and its celerity.

3. A hydroelectric system as in claim 1 which features a vacuum suction force upstream of the spherical valve which results after the sudden expulsion of high compressed water jet from the main penstock (9), said sudden conversion of pressure energy into kinetic energy causes a precipitous drop of pressure into a low pressured partial vacuum inside the main penstock; thus a pressure differential with the higher pressure coming from the elevation head of at least 3 meters plus the atmospheric pressure of 10.3 meters of water force would pull in a volume of water as it rapidly seeks pressure equilibrium in the main penstock.

4. A hydro-electric system of claim 1 which features an auxiliary pump (24) powered by an electric motor that will draw water from the main reservoir (1) into the main penstock (9) to provide additional water volume and pressure needed for the next water hammer.

5. A hydro-electric system of claim 1 which features an auxiliary pump line (25) that connects the auxiliary pump (24) to the main penstock; said pump line having an inside diameter of one half that of the main penstock.

6. A hydro-electric system of claim 1 which features an auxiliary uni-direction spherical valve (26) that has the same dimensions and rotation speed as the main spherical valve (5); both spherical valves rotate in a manner such that the water flow through the auxiliary spherical valve (26) is a short moment before the opening phase of the main spherical valve (5); and the closure of the auxiliary valve is also in advance of the closure of the main spherical valve to prevent the dissipation of the positive water hammer pressure.

7. A hydro-electric system of claim 1 which features a convergence recoil nozzle (29) which is attached to the outflow side of the spherical valve (5) wherein the recoil force of the jet pushes a piston rod (31) to do work.

8. A hydroelectric system of claim 7 where the recoil piston is inside the pressure chamber (30) forcing liquid into the pressure pipe (34) to do work; said recoil piston being supported by columns (29-c) that moves it along guide rails (29-d), said recoil piston having a mechanical spring (29-e) to store energy during compression and is used to push the nozzle back to the original position; and an air relief orifice (29-b) that allows air to move freely in and out of the air chamber (29-a) during operations.

9. A hydroelectric system of claim 8 where the pressure chamber (30) has an inlet vacuum suction pipe (32) that pulls water from the tail reservoir (17) during low pressured expansion and an outlet pressure pipe (34) that provides pressurized liquid during compression to do works; said pipes (32 and 34) being controlled separately by check valves (33 and 35).

10. A hydro-electric system of claim 8 where the compressed liquid from the pressure pipe (34) works as an added pressure force to the main penstock (9) plus adding more water volume to the main penstock.

11. A hydroelectric system of claim 7 where the reciprocating piston (31) drives a linear to continuous rotary assembly where the rotating element is coupled to the rotor of a generator to produce electricity.

12. A hydroelectric system of claim 7 where the piston drives a pressure force into a desalination tank where salts and solutes are removed by filtration membrane.

13. A hydro-electric system of claim 1 where the uni-direction spherical valve (5) is the recoiling assembly; doing without the convergence recoil nozzle; said recoil assembly being complete with all the accessories with functions similar to those mentioned such as the pressure chamber, piston rod, outlet pressure pipe, inlet suction pipe, spring, air chamber, air relief orifice, columns and rail guide.

14. A hydroelectric system of claim 1 which features a series of surge tanks situated near the beginning upstream of the main penstock and are fitted with one way valves (4) that are normally closed at its top, to accumulate compressed air pressure as the surging level of high pressured water pushes up to the upper part of the tanks during the water hammer formation phase; whereby the stored energy is released as pressure force into the main penstock flow during the de-compression phase; this compressed air presents a physical liquid-gas interface dynamic force that consumes no electric energy; whereby as the pressure inside the tanks drops below the existing atmospheric pressure, the one way valve will open to rush in atmospheric pressure air that pushes down further the water level in the tanks, leading the water pressure into the main penstock flow, without consuming any electric energy.

15. A hydro-electric system of claim 1 which features a Pelton turbine-generators with capacity ranging from 50 MW and up, having inertia flywheels with substantial mass to store and to release back mechanical force so as to even out the pulsating mode of jet force, thereby sustaining the optimum frequency of the rotor; and thus a rotational force is conserved by inertia and released to the consuming rotating rotor without using any electrical energy.

16. A hydroelectric system of claim 1 which features a variable speed motor pump (6) having pressure head at a range of 130 to 400 meters and up with motor power of sufficient capacity; whereby upon starting, it would need to accumulate about one minute of the water flowing energy to establish a steady state flow velocity head of at least 5 meters in the main penstock, together with the hydraulic gradient pressure energy head serve as the initial primary force of the system for water hammer pressure and sets the process of power conversions to proceed.

17. A hydroelectric system of claim 1 that will form a distinctive energy loop comprising of various forms of energy inputs and a SINGLE consolidated form of energy output as electricity.

18. A hydro-electric system of claim 17 which features a starting/re-boosting generator (3) which can be substituted by an existing utility power source; said starting/re-boosting generator is the source of the initial input of power for the main pump and the spherical valve; whereby its power line will be closed upon the switch on of the main generator (15); whereby as with any moving energy system subjected to dissipative frictions and gravity, energy loses may reach a point where re-boosting the energy level is needed; periodically, the energy of the system need to be given a boost by an out of the energy loop re-boosting pump (27) powered by electric energy from this re-boosting generator to restore the energy output level.

19. A hydro-electric system of claim 18 that features a second main penstock having the same equipment of the same dimensions with similar functions and is arranged in opposite direction to the other main penstock.

20. A hydro-electric system of claim 19 that features the two oppositely-sited spherical valves moving in an alternating manner and in a rotational mode of storing and releasing water hammered jets to keep the Pelton turbine-generator running at optimum power.

21. A hydro-electric system of claim 20 which features a stream of convertible energy inputs comprising eight forms of force: among them only one form of force would require a substantial amount of electric energy—that being (a) the pressure heads of motor pumps; while the other seven forms of force being natural; physical and air—liquid interface dynamics induced forces and conversions:
(b) the gravitational force induced elevation heads in the main reservoir and in the tail reservoir and which also induced the atmospheric pressure head of 10.3 meters of water and the specific weight of the water medium;
(c) the velocity head of the water jet released from the main penstock converted from high water hammer pressure induced by the “rapid closure” of the spherical valve; (d) the induced vacuum suction force after the sudden huge expulsion of water jet, the partial vacuum state is created that would force higher pressured water to rush into lower pressured area; (e) the equal and opposite in direction recoil force produced by the ejecting jet as according to Newton's third law of motion; (f) the accumulated compressed air pressures in the surge tanks during high compression phase; (g) the prevailing atmospheric air pressure that pushes down into the surge tanks during low pressured expansion phase; (h) the rotational inertia force of the rotor in motion.

22. A hydroelectric system of claim 21 from that can be expressed as an energy/mass equilibrium wherein the convertible Energy Bundles/Mass inputs must be equal to the Energy output plus the Energy/Mass Losses; the convertible energy/mass inputs consisting of:
a) gravitational force induced elevation heads of the main reservoir and the tail reservoir;
b) velocity head of about 1200 m. jet released from converted water hammer pressure that involves the converted latent kinetic energy of the atmospheric liquid;
c) vacuum suction force formed after sudden huge discharge in the main penstock pulling in volume of water directly from the main reservoir; d) recoil force of the jet;
e) compressed air pressure energy inside the surge tanks worked by the surging water during the compression phase;
f) atmospheric air pressure of 10.3 meters of water that pushes into the surge tanks during the de-compression phase;
g) rotation inertial force of the rotor in motion;
h) mechanical force of electric motors, i.e., main pump; the auxiliary pump; the periodic re-boosting pump and the uni-direction spherical valves;
i) mass of water added to the main reservoir as needed through the replenishment pipe; the energy output is the generated electrical energy of at least 50 MW;
the energy/mass losses consist of: a) frictional head loss; b) energy loss as heat; c) pipe wall expansion energy loss; d) machineries efficiency loss; e) evaporation of water molecules.

23. A hydroelectric system of claim 1 which features a single consolidated output of energy that is more than the single form energy input which is the mechanical force of the motor pumps (6; 24; 27); the principle of this power conversion can be compared to a wind turbine electric generation system wherein the single power input is the nature's wind force and the single output is the electrical energy; whereas in this present power conversion system, the multiple inputs are also mostly natural forces working in tandem with a single form of electric based power input and the output being the single consolidated electrical energy; this electricity generation system is not based solely on one form of energy input, but a multitude of energy inputs which are mostly natural forces producing a single consolidated electric energy output bigger than the only one form of electric energy based motor power input.

24. A hydro-electric system of claim 1 which features a closed loop of flow path: from a ground level reservoir (1) with at least three meters of elevation head, water is given a boost in pressure head by a main motor pump (6) to push forward into a 1200 meter long main penstock (9), passing by pressure relief valve (12), surge tanks (13-A & 13-B), vacuum suction pipes (19-A; 19-B & 19-C), pressure re-boosting pipes and ends with motorized uni-direction spherical valve (5) high up inside the powerhouse (11); the continuously rotating spherical valve stops the fast water column in a “rapid closure” mode, transforming the combined kinetic; pressure and elastic energy in the entire water column mostly into a water hammer of immense pressure energy; as the spherical valve opens, pressurized water is re-transformed into a high kinetic energy jet that shoots out of the main penstock (9) to impinge on the Pelton turbine-generator to generate electrical power; the spent water now falls into the tail reservoir (17); from the tail reservoir, water is drained by gravitational force through the outflow pipe (18) back to the original main reservoir (1) completing the loop; and the cycle continues.

25. A hydro-electric system as in claim 1 that features a complementary sub-loop of water path: when the uni-directional spherical valve (5) is opened, huge volume of water jets out of the main penstock (9), and a vacuum suction force is formed that would pull in water from the main reservoir (1) directly into the main penstock (9) through the vacuum suction pipes (19-A; 19-B & 19-C) bypassing the main pump and the rest of the upstream main penstock; supported by the water from the pressure pipe (34) and the water from the auxiliary pump line (25), the full volume of water Is flowed on to the Pelton turbine-generator and then tail reservoir in the powerhouse, and flows out by gravitational force back to the main reservoir (1) completing the sub-loop; and the cycle continues.

26. A hydro-electric system as stated in claim 25 which features a second embodiment wherein the force of pressure head is provided by the main pump (6) and is being substituted by the force of elevation head (derived from gravitational force) from an upper reservoir (22) on top of a mountain plateau; the other equipments and structures of the system are identical in dimensions and functions to the first embodiment.

27. A hydroelectric system of claim 26 which features a motor pump (23) that will deliver water from the lower level up to the upper reservoir (22) for used as elevation head for re-circulation.

28. A hydroelectric system of any claim 27 wherein the liquid used is not water but other liquid such as oil, elemental mercury or others; for such liquids, the penstocks should be re-sized to suit their respective sets of density; volume modulus of elasticity; viscosity and vapor pressure.
